(19) United States
(12) Patent Application Publication
(10) Pub. No.: US 2002/0075597 A1
(43) Pub. Date: Jun. 20, 2002

(54) Method and apparatus for folding thin flexible parts that are used in a disc drive

(75) Inventor: Niandong Liu, Apple Valley, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Seagate Technology LLC

(21) Appl. No.: 09/999,720

(22) Filed: Oct. 26, 2001

Related U.S. Application Data
(60) Provisional application No. 60/257,126, filed on Dec. 20, 2000.

(51) Int. Cl. G11B 5/60; G11B 15/64; G11B 21/20

(52) U.S. Cl. 360/234; 29/603.03

(57) ABSTRACT

The present invention relates to a method and apparatus for folding a thin part such as the tail of a Flexible Circuit On Suspension or Traces Suspension Assembly that are used in a disc drive. The method comprises securing a portion of the thin part and then directing a fluid at the thin part to bend an unsecured portion of the thin part relative to the secured portion of the thin part. The apparatus comprises a fixture for securing the thin part and a fluid emitter positioned near the fixture to direct a fluid at the thin part such that the fluid bends the thin part relative to the fixture. The method and apparatus of the present invention are much more efficient than manually folding thin parts and eliminate any harmful contact between the thin parts and moving tools during the folding operation.

### RELATED APPLICATION

This application claims the benefit of U.S. Provisional Application Serial Number 60/257,126, filed Dec. 20, 2000 under 35 U.S.C. 119(e).

### FIELD OF THE INVENTION

The present invention relates to the field of disc drives. More particularly, this invention relates to a method and apparatus for folding the tail of a Flexible Circuit On Suspension or Traces Suspension Assembly that are used in a disc drive.

### BACKGROUND OF THE INVENTION

One key component of any computer system is a device to store data. Computer systems have many different places where data can be stored. One common place for storing massive amounts of data in a computer system is on a disc drive. The most basic parts of a disc drive are a disc that is rotated, an actuator that moves a transducer to various locations over the disc, and electrical circuitry that is used to write and read data to and from the disc. The disc drive also includes circuitry for encoding data so that it can be successfully retrieved and written to the disc. A microprocessor controls most of the operations of the disc drive including retrieving and storing data onto the disc.

The transducer is typically placed on a small ceramic block which is referred to as a slider. The slider is aerodynamically designed to pass over the disc in a transducing relationship with the disc. As the disc rotates various forces act on the slider so that the slider flies over the surface of the disc at a particular desired fly height. The fly height is the distance between the disc surface and the transducer. The fly height eliminates the friction and resulting wear that would occur if the transducer and disc were in mechanical contact during disc rotation.

Information that is in the form of data is stored on the surface of the disc. The data is divided or grouped together on certain portions or “tracks” on the disc. On some discs the tracks are a multiplicity of concentric circular tracks while on other discs the track is one continuous spiral on one side of the disc. Disc drive systems are configured to read and write information that is stored on the disc in one or more of the tracks.

There is typically one transducer located on each side of a storage disc. The transducers read and write information to/from the storage discs when the transducers are accurately positioned over one of the designated tracks on the surface of the storage disc. As the storage disc spins, the transducer is accurately positioned above a target track where the transducer is able to store data onto a track by writing information representative of data onto the storage disc. Similarly, reading data on a storage disc is accomplished by positioning the transducer above an appropriate track and reading the stored material from the storage disc.

During operation of the disc drive, the slider is moved radially across the tracks by the actuator assembly. The disk drive control system moves the actuator assembly to the appropriate position using servo information. The servo information is also used to hold the transducer in a steady position during a read or write operation.

The actuator assembly is typically either linear or rotary in nature. A rotary actuator is composed of many parts that contribute to accurately holding the transducers in the proper position during a read or write operation. Rotary actuators typically include a pivot assembly, a voice coil yoke assembly and one or more arms which often each include an associated head gimbal assembly.

The voice coil yoke assembly includes a voice coil motor that rotates the pivot assembly about a shaft to position the transducers over particular tracks on the discs. One end of each arm is coupled to the pivot assembly and the other end of each arm is usually attached to a head gimbal assembly. The head gimbal assembly includes a suspension or load beam that serves to support the transducers and restrict motion with respect to the radial and circumferential directions of the disc. A typical head gimbal assembly includes a gimbal that allows a transducer to pitch and roll and follow the topography of an imperfect disc surface.

The transducer on the slider of the head gimbal assembly is attached to a stiff lead. The stiff lead can be any device that is used to carry signals to and from the transducer to the computer. The stiff lead is typically a copper wire that protrudes from either a polyamide flex cable which is commonly referred to as a flex circuit on suspension arrangement (“FOS”), or a suspension that is part of a trace suspension assembly (“TSA”).

Both FOS and TSA devices typically include a folded tail portion that aids in structurally and electrically connecting the devices to some other portion of the disc drive such as a printed circuit board or an adjoining stiff lead. The tails of the FOS and TSA devices are usually manually fabricated by using tweezers to fold the tail. Folding the tails in this manner is extremely time-consuming and cumbersome due to the miniature size of the tails. Manually folding the tails also results in inconsistent bend quality, improper fold locations and damage to the current carrying portions of the tails due to excessive handling.

FOS and TSA tails are also automatically folded by using a roller to roll the tail over an anvil. During the rolling operation the roller rubs against the tail as it plastically deforms the tail to form the bend angle. As the roller is forcibly maneuvered over the tail, the roller often damages the cover coat of the tails and/or the current-carrying copper traces that are part of tails.

What is needed is a method and apparatus for folding thin parts such as the tails of FOS or TSA devices in a disc drive. More specifically, what is needed are a method and apparatus that reliably and consistently bends the tails of FOS and TSA devices that are used in disc drives. These thin parts must be folded such that they are rugged and stable over the life of the disc drive.

### SUMMARY OF THE INVENTION

The present invention relates to a method of folding a thin part such as the tail of a flexible circuit on suspension or a trace suspension assembly that are used in a disc drive. The method includes securing a portion of the thin part and then directing a fluid at the thin part to bend an unsecured portion of the thin part relative to the secured portion of the thin part.

The present invention is also directed to an apparatus for folding a thin part of a disc drive. The apparatus includes a fixture for securing the thin part and a fluid emitter positioned near the fixture to direct a fluid at the thin part such that the fluid bends the thin part relative to the fixture. In one embodiment, the fluid emitter is integral with the fixture and includes a plurality of nozzles that direct the fluid at the thin part from different angles relative to the thin part. In another embodiment, the fixture includes a mandrel that is positioned near the thin part such that the fluid which is ejected by the fluid emitter bends the thin part against the mandrel.

The method and apparatus described for folding a thin part of a disc drive are much more efficient than manually folding thin parts. In addition, the method and apparatus eliminate any contact between the thin parts and any moving tools during the folding operation. Since there is no contact between the thin parts and moving tools, the method and apparatus produce uniform and undamaged thin folded parts resulting in a robust disc drive that is more dependable over its life.

### BRIEF DESCRIPTION OF THE DRAWINGS

FIG. 1 is an exploded view of a disc drive with a multiple disc stack.

FIG. 2 is a perspective view illustrating an apparatus for folding a thin part that is used in a disc drive with the tail of an FOS device positioned within the apparatus.

FIG. 3 is an exploded perspective view of the apparatus and FOS device shown in FIG. 2.

FIG. 4 is an enlarged perspective view of a portion of the apparatus shown in FIGS. 2 and 3.

FIG. 5 is a side view of the portion of the apparatus shown in FIG. 4 illustrating one portion of the method of the present invention.

FIG. 6 is a side view similar to FIG. 5 illustrating another portion of the method of the present invention.

FIG. 7 is a side view similar to FIGS. 5-6 illustrating another portion of the method of the present invention.

FIG. 8 is a side view similar to FIGS. 5-7 illustrating still another portion of the method of the present invention.

FIG. 9 is a side view similar to FIGS. 5-8 illustrating yet another portion of the method of the present invention.

FIG. 10 is an enlarged perspective view illustrating the tail of a FOS device.

FIG. 11 is a view similar to FIG. 10 illustrating the tail of FIG. 10 where the tail has been bent using the apparatus or method of the present invention.

FIG. 12 is a schematic view of a computer system.

### DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

The invention described in this application is useful with all mechanical configurations of disc drives having either rotary or linear actuation. In addition, the invention is also useful in all types of disc drives including hard disc drives, zip drives, floppy disc drives and any other type of drives.

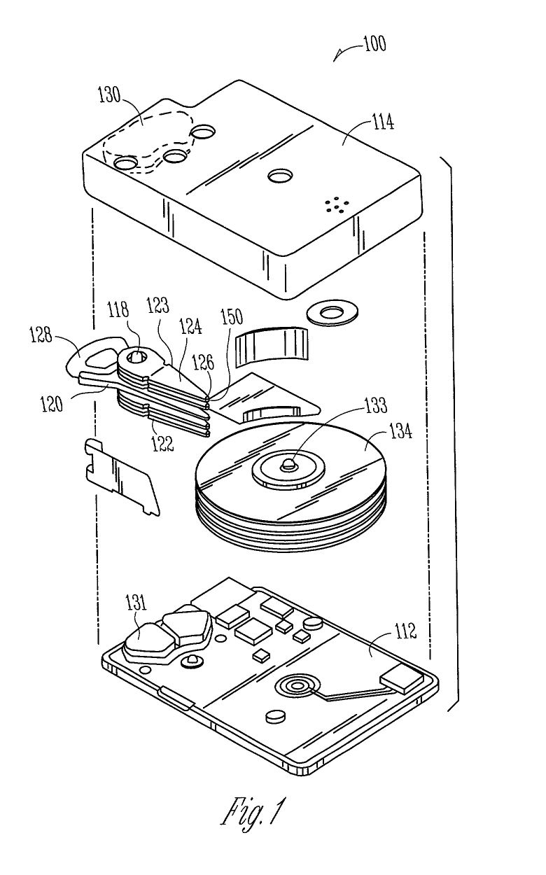

FIG. 1 is an exploded view of one type of a disc drive 100 having a rotary actuator. The disc drive 100 includes a base 112 and a cover 114 that form a disc enclosure. Rotatably attached to the base 112 on an actuator shaft 118 is an actuator assembly 120. The actuator assembly 120 includes a comb-like structure 122 having a plurality of arms 123. Each of the separate arms 123 on the comb 122 include load beams or load springs 124. Attached at the end of each load spring 124 is a slider 126 which carries a magnetic transducer 150. The slider 126 with the transducer 150 form what is typically referred to as the head. It should be noted that many sliders have one transducer 150 and that is what is shown in the figures. It should also be noted that this invention is equally applicable to sliders having more than one transducer, such as what is referred to as a MR or magneto resistive head in which one transducer 150 is generally used for reading and another is generally used for writing. On the end of the actuator arm assembly 120 opposite the load springs 124 and the sliders 126 is a voice coil 128.

Attached within the enclosure are a first magnet 130 and a second magnet 131. As shown in FIG. 1, the second magnet 131 is associated with the base 112. The first and second magnets 130, 131, and the voice coil 128 are the key components of a voice coil motor which applies a force to the actuator assembly 120 to rotate it about the actuator shaft 118. A spindle motor is also mounted to the base 112. The spindle motor includes a rotating portion called a spindle hub 133. In this particular disc drive, the spindle motor is within the hub 133.

In FIG. 1, a number of discs 134 are attached to the spindle hub 133. In other disc drives a single disc or a different number of discs may be attached to the hub. The invention described herein is equally applicable to disc drives which have a plurality of discs as well as disc drives that have a single disc. The invention described herein is also equally applicable to disc drives with spindle motors which are within the hub 133 or under the hub.

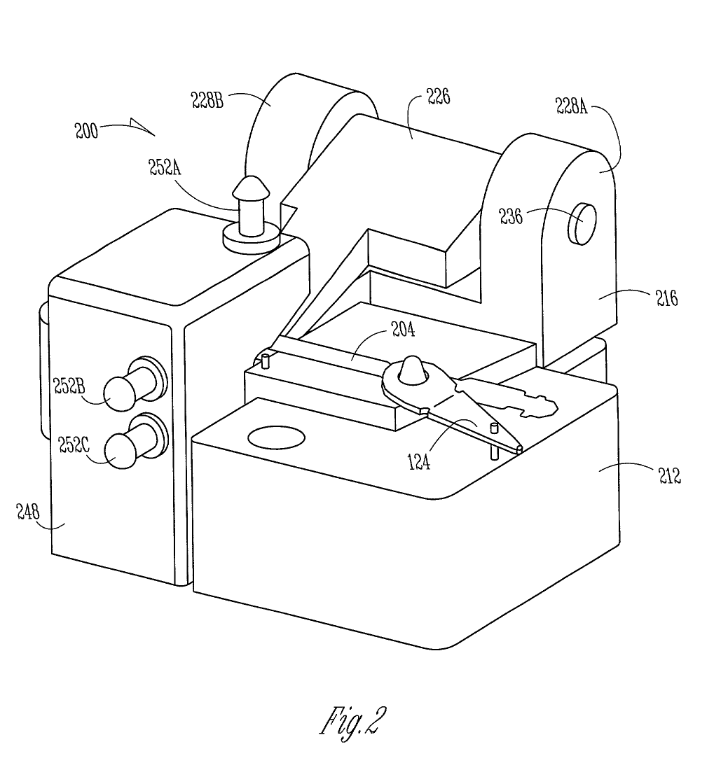

FIG. 2 is a perspective view illustrating an apparatus 200 for folding a thin part that is used in a disc drive 100 of the present invention. The apparatus 200 is adapted to hold a load beam 124 that is used in a disc drive. An FOS device 204 is secured along the side of the load beam 124. The FOS device 204 is oriented such that a tail 208 (not visible in FIG. 2) on the FOS device 204 is positioned within the apparatus 200 in order to bend a portion of the tail 208.

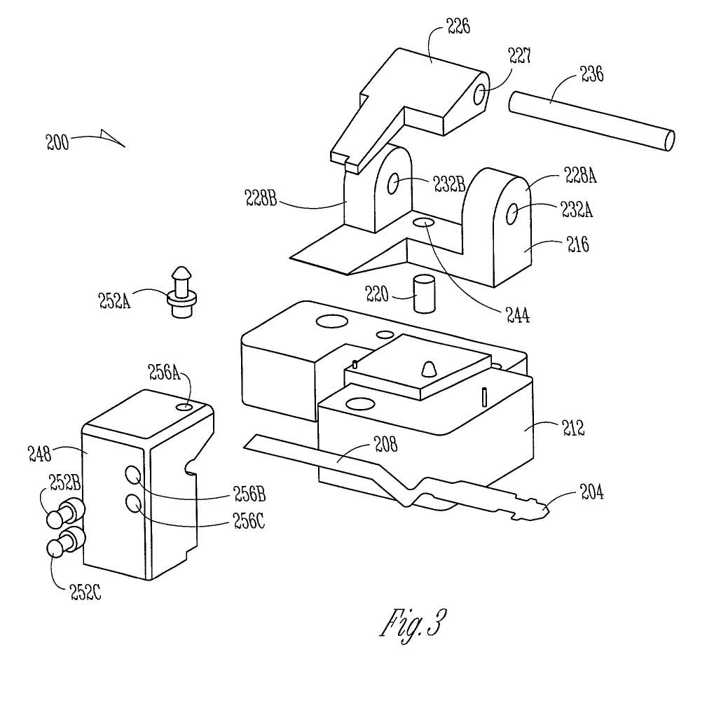

Referring now also to FIG. 3, the apparatus 200 includes a base 212 and a mandrel 216 positioned on the base 212. The mandrel 216 and the base 212 are aligned relative to one another by inserting a pin 220 into an opening in the top of the base 212 and a corresponding opening (not visible in any of the FIGS) in the bottom of the mandrel 216. The mandrel 216 and the base 212 may be secured together using fasteners (not shown) or by any other known method including, but not limited to, welding or adhesives.

The apparatus 200 further includes a clamp 226 that is rotatably mounted to upwardly extending sidewalls 228A, 228B on the mandrel 216. The sidewalls 228A, 228B each include openings 232A, 232B that are axially aligned relative to one another and an opening 227 in the clamp 226. A pin 236 extends through the aligned openings in the clamp 226 and the mandrel 216 to rotatably mount the clamp 226 to the mandrel 216.

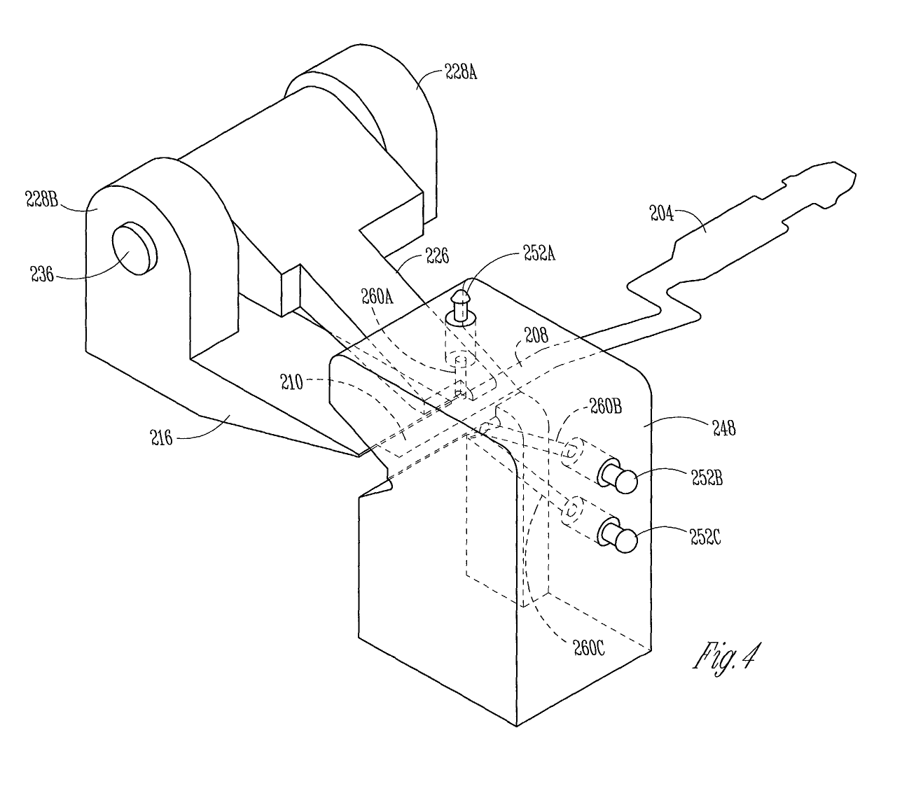

The apparatus 200 also includes a fluid emitter 248 that is positioned against the base 212. The fluid emitter 248 includes nozzles 252A, 252B, 252C that are inserted into openings 256A, 256B, 256C in the fluid emitter 248. The nozzles 252A, 252B, 252C are opened to eject air out of the fluid emitter 248 through holes 260A, 260B, 260C (FIGS. 5-9) that are in fluid communication with the outlet of the nozzles 252A, 252B, 252C. It should be noted that although the fluid emitter 248 is positioned against and aligned relative to the base 212, the fluid emitter 248 could be aligned relative to any other part of the apparatus 200, including parts not shown in the FIGS.

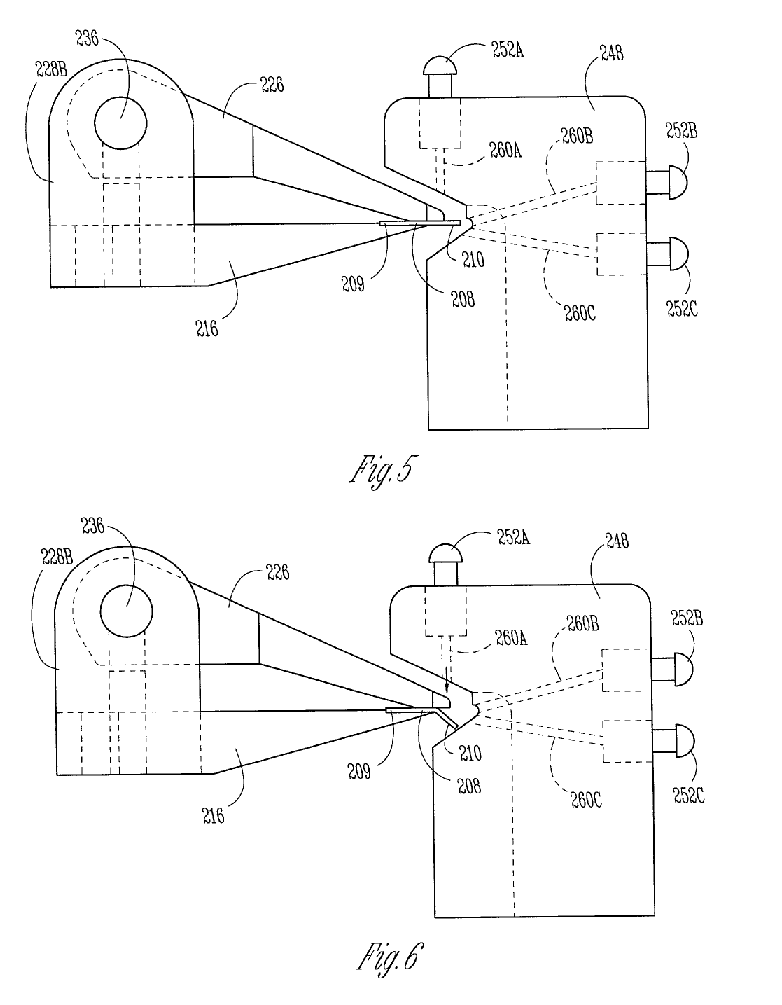

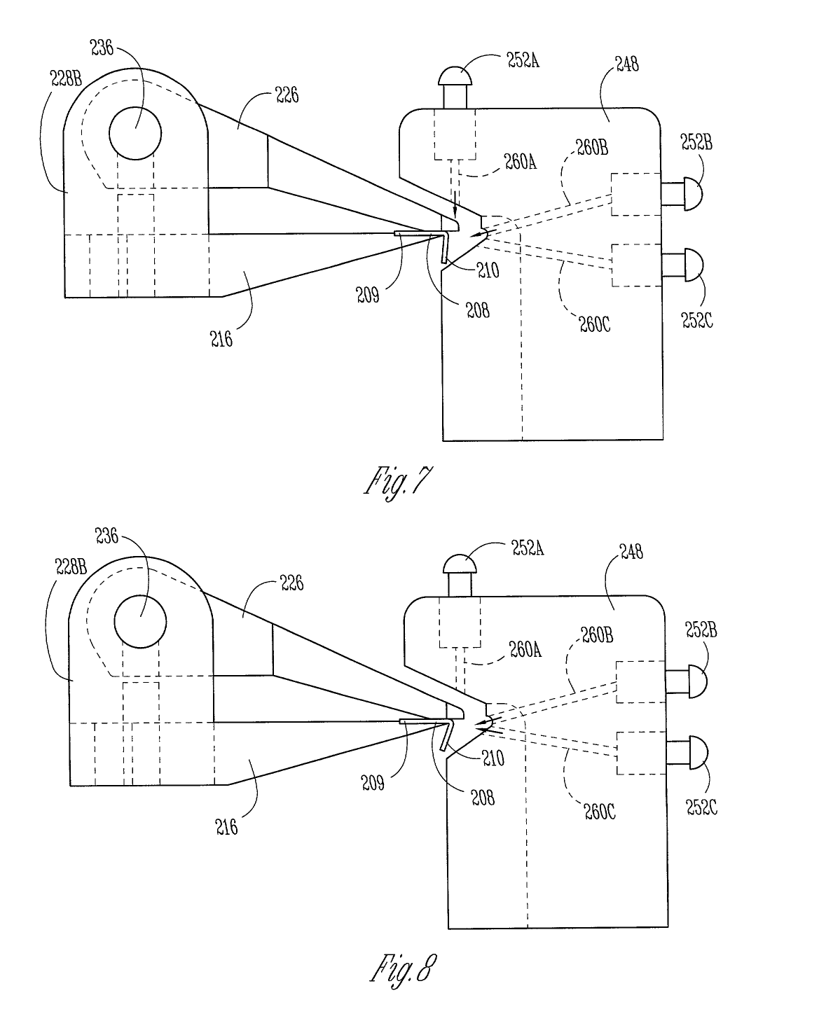

Referring to FIGS. 4 and 5, a portion 209 of the tail 208 on the FOS device 204 is secured between the clamp 226 and the mandrel 216 such that there is an exposed section 210 of the tail 208 located adjacent to the holes 260A, 260B, 260C in the fluid emitter 248. As shown in FIG. 6, the folding operation begins by delivering a fluid, preferably air, through the first nozzle 252A into a hole 260A. The hole 260A directs the fluid at the exposed section 210 of the tail 208. The fluid is traveling with sufficient velocity to bend the exposed section 210 of the tail 208 relative to the secured portion 209. Once the fluid has bent the exposed section 210 of the tail 208 additional fluid is delivered through the second nozzle 252B into another hole 260B. The hole 260B directs the additional fluid at the exposed section 210 of the tail 208 (see FIG. 7) to further bend the exposed section 210 of the tail 208. As shown in FIG. 8, once the fluid from the second nozzle 252B has further bent the exposed section 210 of the tail 208, more fluid is delivered through the third nozzle 252C into another hole 260C. The hole 260C directs the fluid from the third nozzle 252C at the exposed section 210 of the tail 208 to further bend the exposed section 210 of the tail 208. The fluid is preferably no longer delivered through the first nozzle 252A before the fluid is initially directed through the third nozzle 252C.

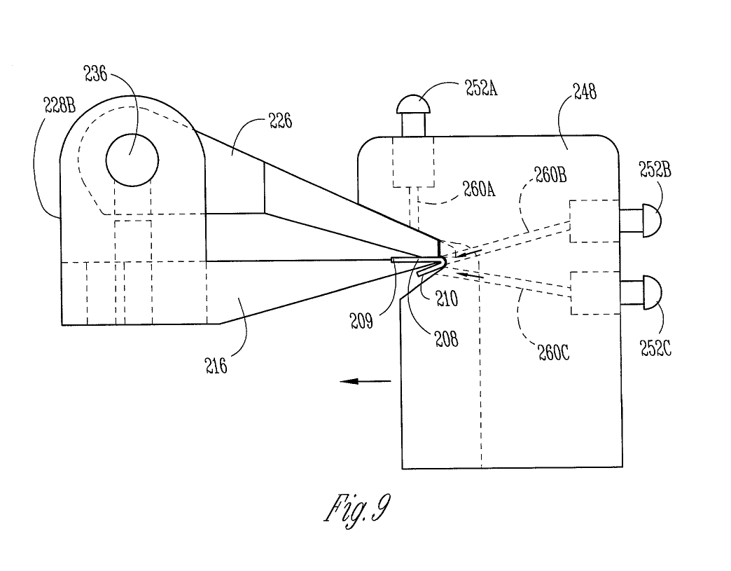

FIG. 9 illustrates that in another embodiment of the method the position of the fluid emitter 248 is adjusted one or more times to facilitate bending the tail 208 of the FOS device 204. It should be noted that although the fluid emitter 248 is preferably moved closer to the exposed section 210 of the tail 208 before the fluid is initially directed from the third nozzle 252C, the fluid emitter 248 may be moved at any time during the bending operation without departing from the scope of the present invention. In addition, the fluid emitter 248 may be moved toward the exposed section 210 of the tail 208 until the fluid emitter 248 engages the exposed section 210 and plastically deforms the exposed section 210 against the mandrel 216.

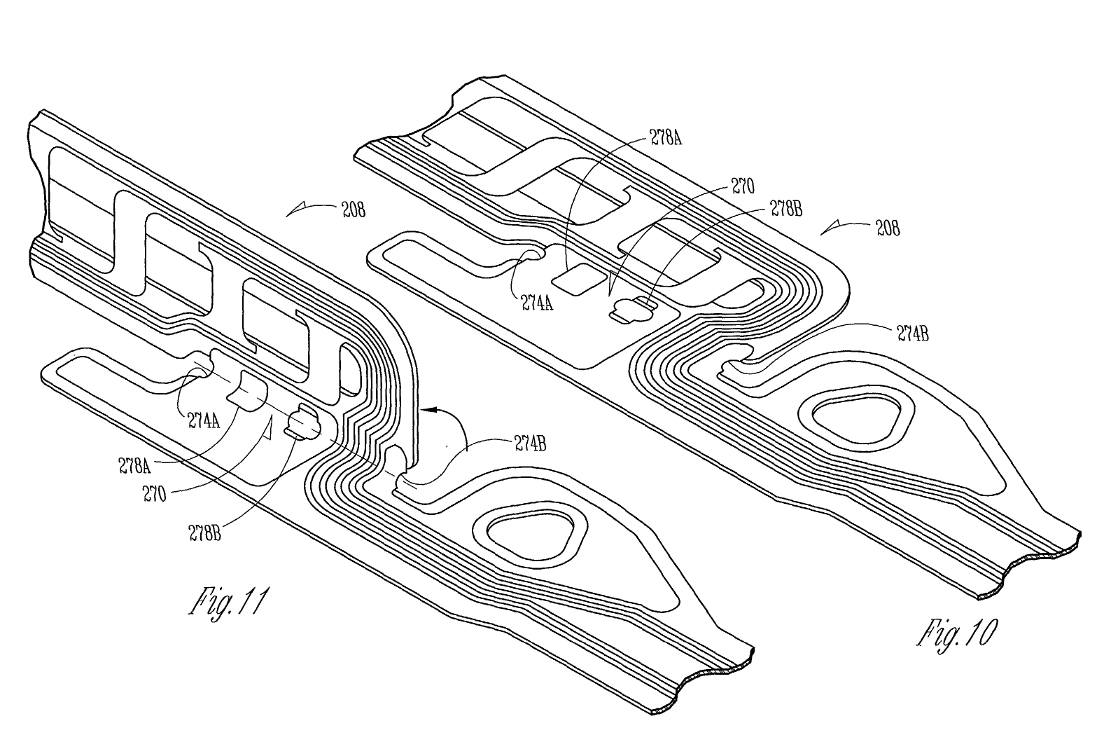

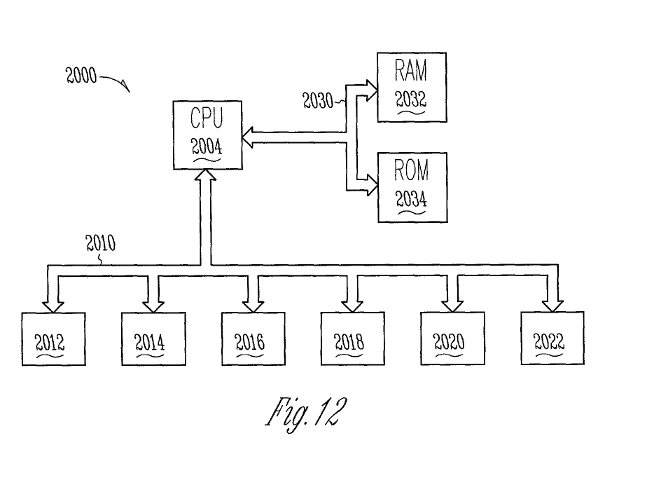

FIGS. 10 and 11 are enlarged views illustrating the tail 208 of a FOS device 204. FIGS. 10 and 11 show the tail 208 before bending (FIG. 10) and after bending (FIG. 11). The tail 208 is preferably designed to include a thinner section 270, and is preferably bent along the thinner section 270 to promote a more consistent bend angle. The thinner section 270 of the tail 208 may additionally, or alternatively, include recessed portions 274a, 274b at the edges of the thinner section 270, and/or openings 278a, 278b along the thinner section 270 to further facilitate consistent bending of the tail 208.

The method and apparatus 200 described for folding the tail 208 of an FOS device 204 is much more efficient than manual folding. In addition, the method and apparatus 200 eliminate or reduce the contact between the tail 208 and any moving tools during the folding operation. Since there is no contact between the tail 208 and the fluid emitter 248, the method and apparatus help to produce undamaged and dependable FOS devices 204 for use in disc drives.

FIG. 12 is a schematic view of a computer system. Advantageously, the invention is well-suited for use in a computer system 2000. The computer system 2000 may also be called an electronic system or an information handling system and includes a central processing unit, a memory and a system bus. The information handling system 2000 includes a central processing unit 2004, a random access memory 2032, and a system bus 2030 for communicatively coupling the central processing unit 2004 and the random access memory 2032. The information handling system 2000 includes a disc drive device which includes the folded tail described above. The information handling system 2000 may also include an input/output bus 2010 and several peripheral devices, such as 2012, 2014, 2016, 2018, 2020, and 2022 may be attached to the input output bus 2010. Peripheral devices may include hard disc drives, magneto optical drives, floppy disc drives, monitors, keyboards and other such peripherals.

In conclusion, a method of folding a thin part such as the tail 208 of an FOS or TAS device in a disc drive is disclosed. The method includes the steps of securing a portion 209 of the thin part 208, and directing a fluid at the thin part to bend an unsecured portion 210 of the thin part 208 relative to a secured portion 209 of the thin part 208. Securing a portion 209 of the thin part 208 may include securing the portion 209 within a fixture 200. The directing step may also include ejecting a fluid from one or more nozzles 252A, 252B, 252C toward the thin part 208 such that the fluid bends the thin part 208. The fluid may be initially directed from a first nozzle 252A for a period of time before the fluid is initially directed from a second nozzle 252B, and may be initially directed from a third nozzle 252C at some period of time after the fluid is initially directed from the second nozzle 252B. In addition, the fluid may no longer be directed from the first nozzle 252A before the fluid is initially directed from the third nozzle 252C. The fluid emitter 248 or any one or more of the nozzles 252A, 252B, 252C may also be moved relative to the thin part 208 before the fluid is initially directed from any of the nozzles 252A, 252B, 252C.

The present invention also relates to an apparatus 200 for folding a thin part 208 such as the tail of FOS and TAS devices in a disc drive 100. The apparatus 200 includes a fixture for securing the thin part 208, and a fluid emitter 248 positioned near the fixture to direct a fluid at the thin part 208 such that the fluid bends the thin part 208 relative to the fixture. The fluid emitter 248 may be integral with the fixture and may include one or more nozzles 252A, 252B, 252C to direct a fluid at the thin part 208 which is secured within the fixture. Each of the nozzles 252A, 252B, 252C may direct the fluid at the thin part 208 from a different angle relative to the thin part 208. In addition, the fixture may include a mandrel 216 that is positioned near the thin part 208 such that the fluid which is ejected by the fluid emitter 248 bends the thin part 208 against the mandrel 216.

The invention generally relates to an apparatus 200 for folding a thin part 208 in a disc drive 100. The apparatus includes a fixture for securing the thin part and means for directing a fluid at the thin part such that the fluid bends the thin part relative to the fixture.

It is to be understood that the above description is intended to be illustrative, and not restrictive. Many other embodiments will be apparent to those of ordinary skill in the art upon reviewing the above description. The scope of the invention should be determined with reference to the appended claims along with the full scope of equivalents to which such claims are entitled.

What is claimed is:

1. A method of folding a thin part of a disc drive, the method comprising the steps of:
(a) securing a portion of the thin part; and
(b) directing a fluid at the thin part to bend an unsecured portion of the thin part relative to the secured portion of the thin part.

2. The method of claim 1 wherein the securing step (a) comprises securing a tail on a flexible circuit on suspension.

3. The method of claim 1 wherein the securing step (a) comprises securing a tail on a trace suspension assembly.

4. The method of claim 1 wherein the securing step (a) comprises securing the portion of the thin part within a fixture.

5. The method of claim 1 wherein the directing step (b) comprises ejecting a fluid through a first nozzle toward the thin part such that the fluid bends the thin part.

6. The method of claim 5 wherein the directing step (b) comprises ejecting a fluid through a second nozzle toward the thin part such that the fluid bends the thin part.

7. The method of claim 6 wherein the directing step (b3) comprises initially directing the fluid through the first nozzle a period of time before initially directing the fluid through the second nozzle.

8. The method of claim 7 wherein the fluid continues to be directed through the first nozzle after the fluid initially directing through the second nozzle.

9. The method of claim 7 wherein the directing step (b) comprises ejecting a fluid through a third nozzle toward the thin part such that the fluid bends the thin part.

10. The method of claim 9 wherein the directing step (b) comprises initially directing the fluid through the third nozzle a period of time after initially directing the fluid through the second nozzle.

11. The method of claim 10 wherein the directing step (b) comprises moving one or more of the first, second and third nozzles relative to the thin part before initially directing the fluid through one of the second and third nozzles.

12. An apparatus for folding a thin part of a disc drive, the apparatus comprising:
(1) a fixture for securing a portion of the thin part; and
(2) a fluid emitter positioned near the fixture to direct a fluid at the thin part such that the fluid bends the thin part relative to the fixture.

13. The apparatus of claim 12 wherein the fluid emitter is integral with the fixture.

14. The apparatus of claim 12 wherein the fluid emitter comprises a nozzle to direct a fluid at the thin part which is secured within the fixture.

15. The apparatus of claim 12 wherein the fluid emitter comprises a plurality of nozzles to direct a fluid at the thin part which is secured within the fixture.

16. The apparatus of claim 15 wherein each of the nozzles directs the fluid at the thin part from a different angle relative to the thin part.

17. The apparatus of claim 12 wherein the fixture comprises a mandrel positioned near the thin part such that the fluid which is ejected by the fluid emitter bends the thin part against the mandrel.

18. An apparatus for folding a thin part in a disc drive, the apparatus comprising:
(a) a fixture for securing the thin part; and
(2) means for directing a fluid at the thin part such that the fluid bends the thin part relative to the fixture.

19. The apparatus of claim 18 wherein the means for directing a fluid at the thin part comprises a plurality of nozzles to direct a fluid at the thin part which is secured within the fixture.

20. The apparatus of claim 19 wherein each of the nozzles directs the fluid at the thin part from a different angle relative to the thin part.
